(19) United States
(12) Patent Application Publication
(10) Pub. No.: US 2014/0083240 A1
(43) Pub. Date: Mar. 27, 2014

(54) APPARATUS FOR SHIFTING GEARS OF A TRANSMISSION

(71) Applicant: HYUNDAI MOTOR COMPANY, Seoul (KR)

(72) Inventor: Chon Ok Kim, Seoul (KR)

(73) Assignee: Hyundai Motor Company, Seoul (KR)

(21) Appl. No.: 13/689,281

(22) Filed: Nov. 29, 2012

(30) Foreign Application Priority Data
Sep. 24, 2012 (KR) 10-2012-0105677

(51) Int. Cl. F16H 25/08

(52) U.S. Cl. CPC F16H 25/08
USPC 74/569

(57) ABSTRACT

An apparatus for shifting gears of a transmission includes a plural control fingers each of which is shaped as a cam form and fitted into a control shaft and rotated together, on which projections are arranged to be distributed at a predetermined angle along a circumferential direction around which the control shaft rotates, and a shift lug that is provided on a shift rail and shaped to accommodate the control finger as plural to contact the respective control fingers and that contacts the projection of the control finger and is pressed when the control shaft rotates so that the corresponding shift rail is shifted to a shifting gear position.

### CROSS-REFERENCE TO RELATED APPLICATION

The present application claims priority of Korean Patent Application Number 10-2012-0105677 filed Sep. 24, 2012, the entire contents of which application is incorporated herein for all purposes by this reference.

### BACKGROUND OF INVENTION

1. Field of Invention

The present disclosure relates to a shifting unit of gears, and more particularly, to an apparatus for shifting gears of transmission, capable of omitting a selecting operation during a shifting of gears and deleting the components for the selecting operation to reduce weight and save cost thereby improving replying property in accordance to the shifting operation.

2. Description of Related Art

Generally, a shifting operation of gears in a manual shifting mechanism is performed such that a shifting lever in indoor space of a vehicle is operated to move a shift cable and a selector cable and to operate a shift lever and a selector lever in accordance to the operations of the two cables for shifting.

In more detail, the selector lever moves a control shaft vertically in accordance to an operation of the selector cable and a control finger connected to the control shaft selects one among a plurality of shift lugs. Here, the shift lug is fixed to a shift rail and a shift fork is fixed together wherein the shift rail is moved by left-right movement of the shift lug and the shift fork moves a sleeve to be shifted to a corresponding shifting stage.

However, according to the prior shifting unit, shifting operation for moving left-rightward the shift lug and selecting operation for moving vertically the control shaft are necessary in order to shift gears wherein a select actuator has to be added to make the shifting unit be complicated and it increases weight and cost thereof.

Further, the shifting operation is performed by a selecting operation and shifting operation wherein it deteriorates the replying property

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been propose to solve the above drawbacks. Various aspects of the present invention provide for an apparatus for shifting gears of a transmission, capable of omitting a selecting operation during a shifting of gears and deleting the components for the selecting operation to reduce weight and save cost thereby improving replying property in accordance to the shifting operation.

Various aspects of the present invention provide for an apparatus for shifting gears of a transmission according to the present invention, including: a plural control fingers each of which is shaped as a cam form and fitted into a control shaft and rotated together, on which projections are arranged to be distributed at a predetermined angle along a circumferential direction around which the control shaft rotates; and a shift lug that is provided on a shift rail and shaped to accommodate the control finger as plural to contact the respective control fingers and that contacts the projection of the control finger and is pressed when the control shaft rotates so that the corresponding shift rail is shifted to a shifting gear position.

The projection protruding outward may be formed on a part of the outer peripheral surface of the control finger, a groove that is in a cut shape is formed on a part of the outer peripheral surface of the control finger, opposing to the projection, and contact portions protruding to the control finger are formed on both sides of the inner peripheral surface of the shift lug, respectively wherein the contact portion contacts the projection and the groove, and is pressed for the shift lug to be shifting-moved.

At the moment when the projection of the control finger is in contact with the contact portion formed on one end of the shift lug, the groove of the control finger may be in contact with the contact portion formed on the other end of the shift lug.

An interlock may be provided as a circumferential surface shape between the projection and the groove of the control finger so that when the interlock is in contact with the contract portion formed on the shift lug, the corresponding part of the shift lug to be in contact with the interlock is not shifting-moved.

When the projection and the groove formed on one of the control fingers are to be in contact with the contact portion formed on the corresponding shift lug, the projection and the groove formed on another of the control fingers can be also in contact with the contact portion formed on the corresponding shift lug and thus two shift lugs can be shifting-moved simultaneously.

The projection and the groove formed on another control finger are to be in contact with the corresponding contact portion to be overlapped right before the projection and the groove formed on one control finger finish being in contact with the corresponding contact portion, and thus two shift lugs can be shifting-moved simultaneously.

The projection and the groove formed on the respective control fingers may be arranged at an uniformly distributed angle along the circumferential direction of a rotation of the control shaft.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a perspective view illustrating an exemplary apparatus for shifting gears of a transmission according to the present invention.

FIG. 2 is a side view illustrating an exemplary apparatus for shifting gears of a transmission according to the present invention.

FIG. 3 is a view illustrating movements of a shift lug in accordance to a rotation of a control finger in an exemplary apparatus for shifting gears of a transmission according to the present invention.

FIG. 4 is a view illustrating two shifting gears being shifted simultaneously for the apparatus for shifting gears of a transmission to be applied to Dual Clutch Transmission (DCT).

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

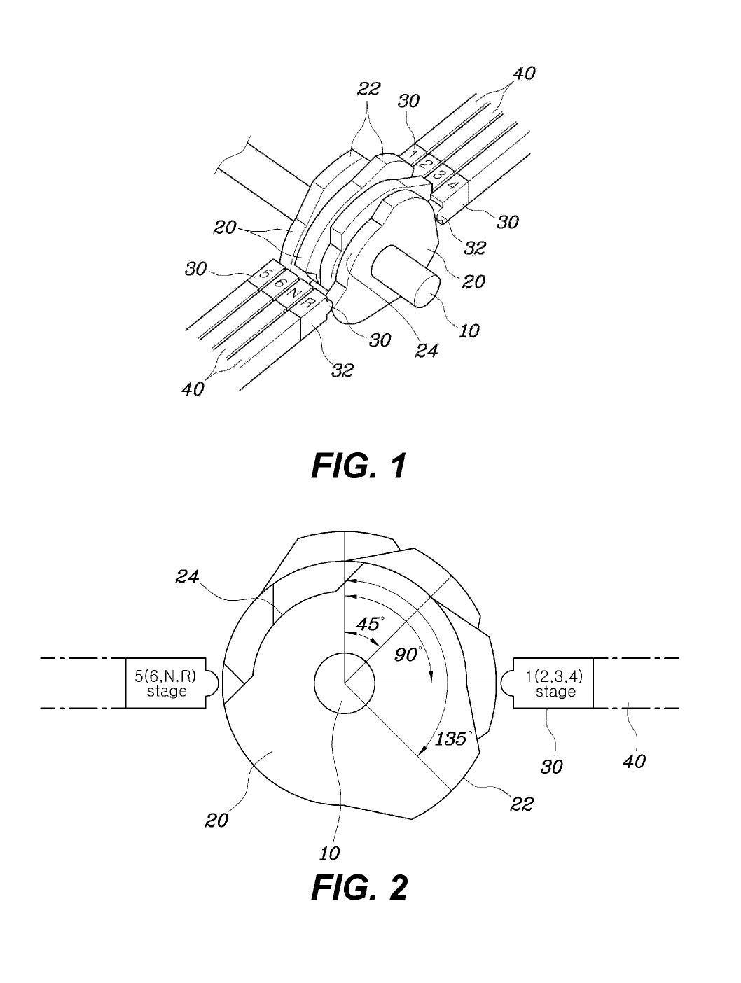

Referring to FIGS. 1 to 4, an apparatus for shifting gears of a transmission according to the present invention may include: a plural control fingers 20 each of which is shaped as a cam form and fitted into a control shaft 10 and rotated together, that is, in unison with the control shaft, on which projections are arranged to be distributed uniformly at a respective predetermined angle along a circumferential direction around which the control shaft 10 rotates; and a shift lug 30 that is provided on a shift rail 40 and shaped to accommodate the control finger 20 as plural to contact the respective control fingers 20 and that contacts the projection 22 of the control finger 20 and is pressed when the control shaft rotates so that the corresponding shift rail 40 is shifted to a shifting gear position.

In more detail, the control finger is shaped as a cam form, provided as plural and fitted into the control shaft 10, each shift lug 30 is fitted into the respective control fingers 20, and each shift rail 40 is fixed to the respective shift lugs 30 so that the shift rail 40 is moved linearly together with the shift lug 30.

That is, when a driver operates a shifting lever for shifting gears, the control shaft 10 connect to the shifting lever through a cable is rotated and the control fingers connected to the control shaft 10 is rotated together. At this time, each control finger 20 is shaped as a cam form and thus any one control finger 20 presses inner peripheral surface of the corresponding shift lug 30 through its projection while the control fingers 20 rotate, and the shift rail 40 connected to the corresponding shift lug 30 is moved to be meshed with the shifting gears connected to the shift rail 40.

Likewise, a shifting operation is performed by a rotation of the control finger 20 without a separate selecting operation and thus the components including a selecting actuator for the selecting operation, etc., are not necessary to reduce weight and cost through reduction of the number of the components and further improve greatly a replying property.

Here, a six-speed of a transmission is exampled in the present invention. Referring to FIG. 1, four control fingers 20 are mounted to the control shaft 10 wherein each of four shift lugs 30 is received in the respective control fingers 20. A first stage and a fifth stage are shifted through a first shift lug 30, a second stage and a sixth stage are shifted through a second shift lug 30, a third stage and a neutral stage are shifted through a third shift lug 30, and a fourth stage and a rear stage are shifted through a fourth shifting lug 30.

That is, in case of the first shift lug 30, when the shift lug 30 is moved toward a first stage, the shift rail 40 and the shift fork are moved together for the shifting gears to be meshed with a first stage, and when the shift lug 30 is moved toward a fifth stage, the shifting gears is to be meshed with a fifth stage.

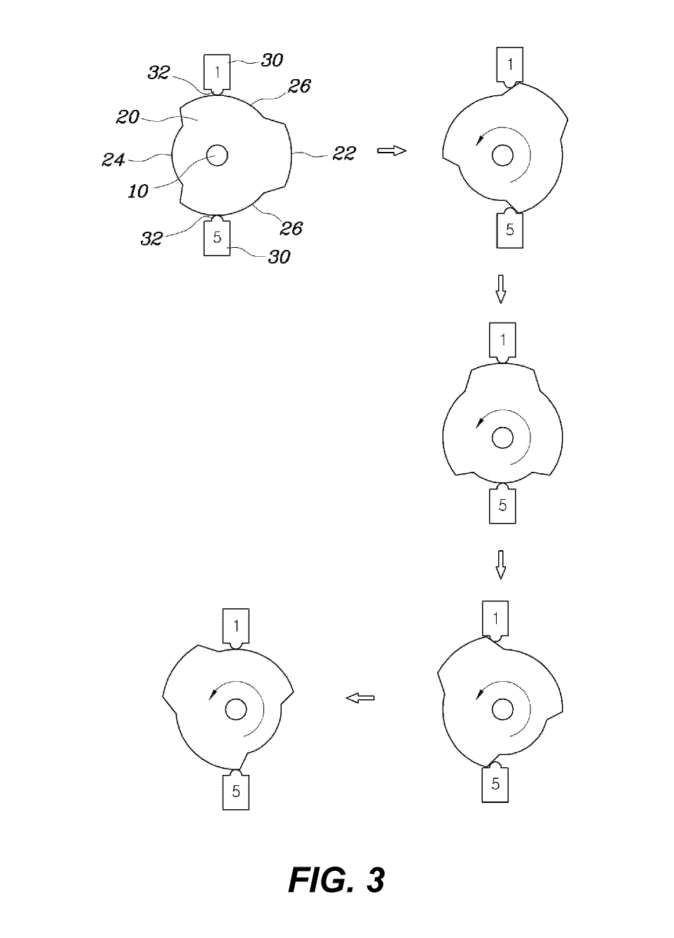

As shown in FIG. 3, the projection 22 protruding outward is formed on a part of the outer peripheral surface of the control finger 20 and a groove that is in a cut shape is formed on a part of the outer peripheral surface of the control finger 20, opposing to the projection 22. Further, contact portions 32 protruding to the control finger are formed on both sides of the inner peripheral surface of the shift lug 30, respectively wherein the contact portion 32 contacts the projection 22 and the groove 24 contact and is pressed for the shift lug 30 to be shifting-moved.

That is, when the control finger 20 is fitted into the corresponding shift lug 30 in a reception shape and the shift lug 30 is moved to a corresponding linear direction by the projection 22 of the control finger 20, the shift lug 30 is to be in contact with the groove 24 formed on an opposite side to the projection 22 and cannot be moved.

Furthermore, in the projection 22 and the groove 24 formed on the control finger 20, at the moment when the projection 22 is in contact with one contact portion 32 formed on the shift lug 30, the groove 24 of the control finger 20 may be in contact with the other contact portion 32 of the shift lug 30.

That is, the projection 22 starts to be in contact with the contact portion 32 formed on one end of the shift lug 30 and at the same time the groove 24 starts to be in contact with the contact portion formed on the other end of the shift lug 30. Likewise, the projection 22 finishes being in contact with one contact portion 32 and then the groove 24 finishes being in contact with the other contact portion 32.

Furthermore, an interlock 26 is provided as a circumferential surface shape between the projection 20 and the groove 24 of the control finger 20 so that when the interlock 26 is in contact with the contract portion 32 formed on the shift lug 30, the corresponding part of the shift lug 30 to be in contact with the interlock 26 is not shifting-moved, that is, in a neutral or initial position.

That is, the control finger 20 is formed as a circular shape except for the projection 22 and the groove 24 and the interlocks 26 are formed on the circumferential surface wherein when the contact portion 32 formed on the shift lug 30 is in contact with the interlock 26, the corresponding shift lug 30 is not to be moved linearly to make shifting operation through the shift lug 30 be impossible.

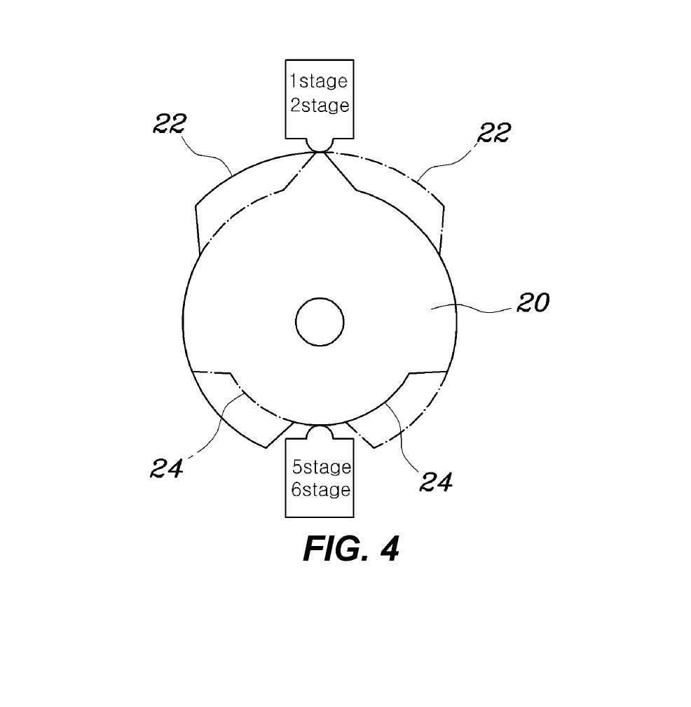

Meanwhile, as shown in FIG. 4, when the projection 22 and the groove 24 formed on one of the control fingers 20 are to be in contact with the contact portion 32 formed on the corresponding shift lug 30, the projection 22 and the groove 24 formed on another of the control fingers 20 can be also in contact with the contact portion 32 formed on the corresponding shift lug 30 and thus two shift lugs 30 can be shifting-moved simultaneously.

In more detail, the projection 22 and the groove 24 formed on another control finger 20 are to be in contact with the corresponding contact portion 32 to be overlapped right before the projection 22 and the groove 24 formed on one control finger 20 finish being in contact with the corresponding contact portion 32, and thus two shift lugs 30 can be shifting-moved simultaneously.

That is, the apparatus for shifting gears of a transmission may be applied to a transmission of Dual Clutch Transmission (DCT) configuration wherein when one shift finger 20 allows the corresponding shift lug 30 to be moved to a shifting direction, another shift finger 20 allows also the corresponding shift lug 30 to be moved to a shifting direction so that two shifting gears are meshed simultaneously during a clutch shifting procedure of DCT.

At this time, the two shifting gears in a meshed state may be gears in high rank stage or low rank stage.

Furthermore, as shown in FIG. 2, the projection 22 and the groove 24 formed on the respective control fingers 20 may be arranged at an uniformly distributed angle along the circumferential direction of a rotation of the control shaft 10.

As one example of 6-speed shifting unit in the present invention, the projection 22 and the groove 24 formed on plural control fingers 20 may be formed at 45° along a circumferential direction wherein the control finger 20 may be arranged such that the shifting gears are meshed in sequence from a low speed stage to a high speed stage, and from the high speed stage to the low speed stage while the control finger 20 rotates.

According to the apparatus for shifting gears of a transmission of the present invention, when the control finger 20 is rotated, the shifting gear can be simultaneously meshed with the rear stage gear and the first stage gear via the rear stage from the neutral stage, and the shifting gear can be independently meshed with the first gear. Continuously, the shifting gear can be simultaneously meshed with the first gear and the second gear, and the shifting gear can be independently meshed with the second stage gear. According to the above-described shifting operation method, the shifting gears can be sequentially meshed from the low-speed stage to the high-speed stage, two shifting gears can be simultaneously meshed, and thus the present invention can be applied to a DCT transmission.

For convenience in explanation and accurate definition in the appended claims, the terms left and right, rear, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An apparatus for shifting gears of a transmission, comprising:
a control shaft;
a plurality of control fingers affixed to the control shaft to rotate in unison with the control shaft, each control finger including a respective cam surface on which a respective projection is arranged at a respective predetermined angle with respect to a circumferential direction of the control shaft; and
a plurality of shift lugs provided on a corresponding plurality of shift rails, each shift lug shaped to interact with a corresponding control finger so that a respective control finger presses against a corresponding shift lug to move a corresponding shift rail to a corresponding shifting gear position when the control shaft rotates to a respective predetermined angle.

2. The apparatus for shifting gears of a transmission of claim 1, wherein each projection is formed on the respective outer peripheral surface of the respective control finger, each control finger further including a respective groove cut in the respective outer peripheral surface opposing the projection, and wherein corresponding pairs of contact portions protrude toward a respective control finger on opposing sides of a respective inner peripheral surface from a corresponding pair of shift lugs, wherein the corresponding pair of contact portions contacts a respective pair of opposing projections and grooves, to move a corresponding pair of shift rails to a corresponding shifting gear position.

3. The apparatus for shifting gears of a transmission of claim 2, wherein when a respective projection of a respective control finger is in contact with a corresponding contact portion formed on one end of a corresponding shift lug, a respective groove of the respective control finger is in contact with a corresponding contact portion formed on another end of a corresponding shift lug.

4. The apparatus for shifting gears of a transmission of claim 2, wherein each control finger includes a respective interlock is provided on a respective peripheral surface between a respective projection and a respective groove so that when the interlock is in contact with the contract portion formed on the shift lug, a corresponding shift lug is in an initial position.

5. The apparatus for shifting gears of a transmission of claim 2, wherein when a first respective projection and groove formed on a first respective control fingers are in contact with a first corresponding pair of contact portions, a second respective projection and groove formed on a second respective control finger is in contact with a second corresponding pair of contact portions so that multiple shift lugs can be shiftingly moved simultaneously.

6. The apparatus for shifting gears of a transmission of claim 5, wherein the first respective projection and groove and the second respective projection and groove overlap so that the first respective projection and groove contact a first corresponding pair of contact portions right before the second respective projection and groove finish contacting with the second corresponding pair of contact portions.

7. The apparatus for shifting gears of a transmission of claim 2, wherein respective projections and grooves are formed on respective control fingers at uniformly distributed angles along the circumferential direction of rotation of the control shaft.
